(19) United States
(12) Patent Application Publication
(10) Pub. No.: US 2004/0253339 A1
(43) Pub. Date: Dec. 16, 2004

(54) Tool for flexible plastic pipe

(76) Inventor: Aden Dale Hiatt JR., Colorado Springs, CO (US)

Correspondence Address: Law Office of Dale B. Halling, LLC, Suite 311, 24 S. Weber St., Colorado Springs, CO, 80903, US

(21) Appl. No.: 10/713,436

(22) Filed: Nov. 14, 2003

Related U.S. Application Data
(60) Provisional application No. 60/477,964, filed on Jun. 12, 2003.

(51) Int. Cl. B29C 57/04

(52) U.S. Cl. 425/392

(57) ABSTRACT

A tool for flexible plastic pipe has a first handle having a first end and a second end. The first end functions as a hand grip and the second end has a first protruding truncated half pipe working portion. A second handle has a first end and a second end. The first end functions as a hand grip and the second end has a second protruding truncated half pipe working portion. A pivot member connects the first handle and the second handle.

### RELATED PATENTS

The present invention claims priority on provisional patent application, Ser. No. 60/477,964, filed on Jun. 12, 2003, entitled “Device to Flare Flexible Plastic Pipe”.

### FIELD OF THE INVENTION

The present invention relates generally to the field of tools and more particularly to the field of tools for flexible plastic pipe.

### BACKGROUND OF THE INVENTION

Installers of flexible plastic pipe for plumbing applications in commercial, residential or other applications presently insert molded plastic fittings into the pipe by forcing the fittings into the pipe. Commonly, the flexible plastic pipe requires that it be flared before the fitting can be inserted into the pipe. The pipe is physically flared with tools not designed for this purpose and sometimes a heat source, such as a torch, is used to soften the pipe. The fittings are often damaged or broken by installers pounding on the fitting to insert them into the flexible pipe. The end of a fitting is inserted into a pipe and a clamp is then installed over the pipe to tightly hold the pipe onto the molded plastic fittings. The pipe may also be damaged during the expansion process. This method of inserting the fittings into the pipe creates potential failure points in the connections.

The tool to crimp the clamp over the pipe and fittings is not the same tool as is used to flare the pipe. This results in the installer having to have multiple tools to install a single fitting. If an error is made during the installation of the fitting, it requires removing the clamping ring. The clamp must usually be removed by cutting the clamp in two.

Thus there exists a need for an improved tool for installing fittings into flexible plastic pipe.

### SUMMARY OF INVENTION

A tool for flexible plastic pipe has a first handle having a first end and a second end. The first end functions as a hand grip and the second end has a first protruding truncated half pipe working portion. A second handle has a first end and a second end. The first end functions as a hand grip and the second end has a second protruding truncated half pipe working portion. A pivot member connects the first handle and the second handle. In one embodiment, the first protruding truncated half pipe working portion and the second protruding truncated half pipe working portion are opposing. In another embodiment, the first protruding truncated half pipe working portion and the second protruding truncated half pipe working portion form an essentially closed pipe when the tool is in an open position.

In one aspect of the invention, the first handle has a female pivot opening between the first end and the second end. In another aspect of the invention, the second handle has a female pivot opening between the first end and the second end.

In one embodiment, the first protruding truncated half pipe working portion is spaced from the second protruding truncated half pipe working portion when the tool is in a closed position. In another embodiment, a first crimping member is on the first handle and a second crimping member is on the second handle. In one aspect of the invention, the first crimping member is between the first end of the first handle and a female pivot opening of the first handle.

In one embodiment, a tool for flexible plastic pipe has a first handle with a first end and a second end. The first end functions as a first part of a hand grip and the second end has a first protruding truncated half pipe working portion. A second handle opposes the first handle and has a first end and a second end. The first end functions as a second part of a hand grip and the second end has a second protruding truncated half pipe working portion. An attachment member is connected to the first handle to the second handle. In one embodiment, a first crimping blade is included on the first handle and a second crimping blade is included on the second handle. In one aspect of the invention, the attachment member is a pivot pin. In one embodiment, the second crimping blade is between the first end of the second handle and the pivot pin. In another embodiment of the invention, the first handle does not cross over the second handle. In one embodiment, a tool for flexible plastic pipe includes a first handle having a first end and a second end. The first end functions as a first part of a hand grip and a first crimping member is formed in the first handle. A second handle has a first end and a second end. The first end functions as a second part of a hand grip and a second crimping member is formed in the second handle. A pivot pin couples the first handle to the second handle, wherein the first crimping member is between the first pivot pin and the hand grip. In one embodiment, the first handle includes a first protruding working portion. In one aspect of the invention, the second handle includes a second protruding working portion. In another aspect of the invention, the first protruding portion is on the second end of the first handle. In another embodiment of the invention, the first protruding working portion and the second protruding working portion are opposing. In one embodiment the tool has a first uncrimping part on the first handle and a second uncrimping part on the second handle. In another embodiment, the second uncrimping part is between the first end of the second handle and the pivot pin.

### BRIEF DESCRIPTION OF THE DRAWINGS

FIG. 1 is a front view of a portion of a plastic pipe, a clamp ring and a fitting in accordance with one embodiment of the invention;

FIG. 2 is a top left perspective exploded view of a tool for flexible pipe in accordance with one embodiment of the invention;

FIG. 3 is a top left perspective view of a tool for flexible pipe in accordance with one embodiment of the invention;

FIG. 4 is a perspective drawing of a tool for flexible pipe used to clamp a ring in accordance with one embodiment of the invention; and

FIG. 5 is a perspective view of a tool for flexible pipe preparing for flaring a flexible pipe in accordance with one embodiment of the invention.

### DETAILED DESCRIPTION OF THE DRAWINGS

FIG. 1 is a front view of a portion of a plastic pipe 10, a clamp ring 12 and a fitting 14 in accordance with one embodiment of the invention. The fitting 14 has a male end 16 with ribs 18 that help hold the fitting 14 in the plastic pipe 10. A clamp ring 12 fits over the plastic pipe 10 and the male end 16 of the fitting 14. The ring 12 has a crimp portion 20 that is used to tighten the ring 12 onto the plastic pipe 10.

FIG. 2 is a top left perspective exploded view of a tool 30 for flexible pipe in accordance with one embodiment of the invention. The tool 30 has a first handle 32 and a second handle 34. The first handle 32 has a first end 36 and a second end 38. The first end 36 functions as a hand grip or part of a hand grip. In one embodiment, the first end 36 has a soft plastic or rubber sleeve 40 covering it. The second end 38 has a first protruding truncated half pipe working portion 42. In another embodiment, the working portion is also a right angle to the handle 32 but is not a half pipe. For instance, the working portion may be a half cylinder, a half hexagon rod, or a rectangular rod or similar shape. Between the first end 36 and the second end 38 is a female pivot opening 43. The pivot opening 43 is formed by a semicircular protrusion with a hole in it center.

The second handle 34 has a first end 44 and a second end 46. The first end 44 functions as a hand grip or part of a hand grip. In one embodiment, the first end 44 has a soft plastic or rubber sleeve 48 covering it. The second end 46 has a first protruding truncated half pipe working portion 50. Between the first end 44 and the second end 46 is a female pivot opening 52. The pivot opening 52 is formed by a semicircular protrusion with a hole in it center. A pivot pin 54 connects the first handle 32 to the second handle 34.

In one embodiment, the first handle 32 has a first crimping blade 56. The first crimping blade 56 is located between the pivot opening 43 and the first end 36 of the first handle 32. The blade is wedge shape that ends in a blunt or flat blade. The second handle 34 has a second crimping blade 58 that is located between the pivot opening 52 and the first end 44 of the second handle 34.

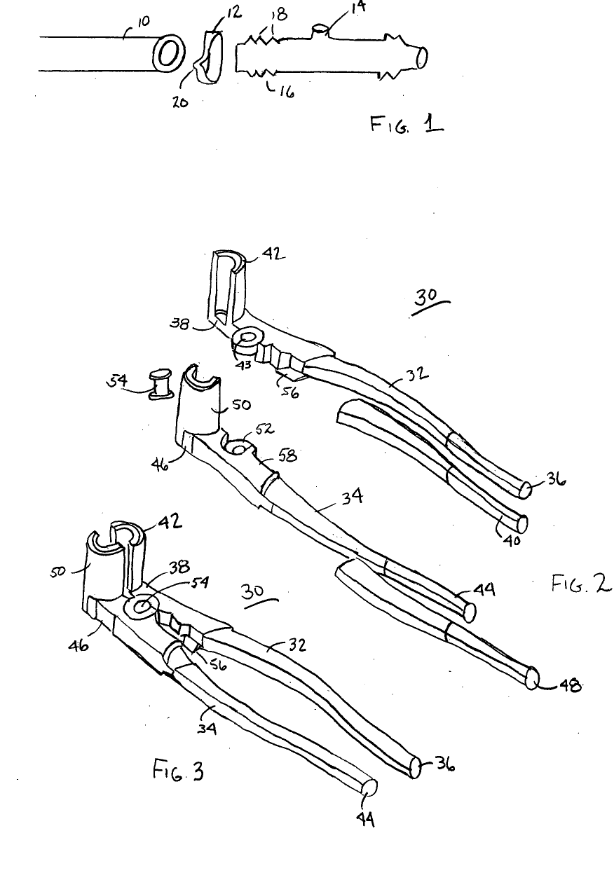

FIG. 3 is a top left perspective view of the tool 30 for flexible pipe in accordance with one embodiment of the invention. The same reference numerals are used in both FIG. 2 and FIG. 3. The operation of the tool 30 will be explained with respect to FIG. 3. As the handles 32 & 34 are closed or in the closed position the working portions 42 & 50 become spaced apart and when the handles 32 & 34 are opened or are in the open position the working portions 42 & 50 form an essentially closed pipe. The tool 30 is placed in the open position and the working portions 42 & 50 are inserted into an end of a plastic pipe 10. The operator places the ring 12 over the pipe 10 and then inserts the male end 16 of the fitting 14 into the pipe 10. The operator then closes the handles 32 & 34 which causes the working portions to space apart from each other and flare the end of the plastic pipe 10. The flaring caused by the tool 30 makes the process significantly easier and does not require pounding on the fitting or heating the pipe. As a result, the chances of damaging the fitting are significantly reduced saving time and money. Next the tool 30 is opened and the crimping blades 56 & 58 are placed over the crimping portion 20 of the ring 12. The tool 30 is closed and the crimping portion 20 is crimped to form a tight seal between the fitting 14 and the pipe 10. Since the same tool is used to flare the pipe 10 and crimp the ring 12, the amount of time required to place a fitting is significantly reduced. The tool saves the installer time and money.

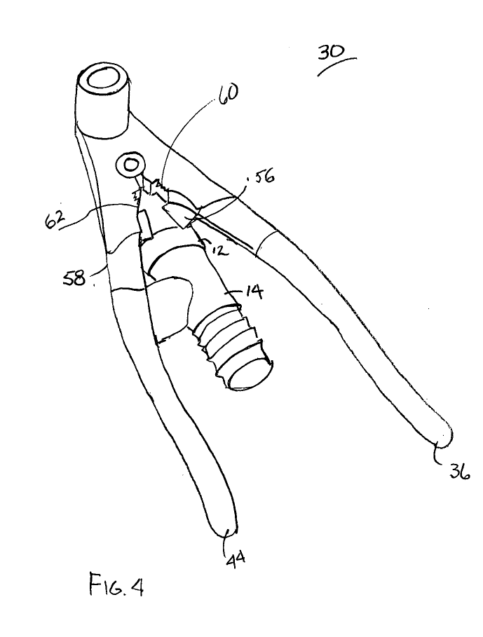

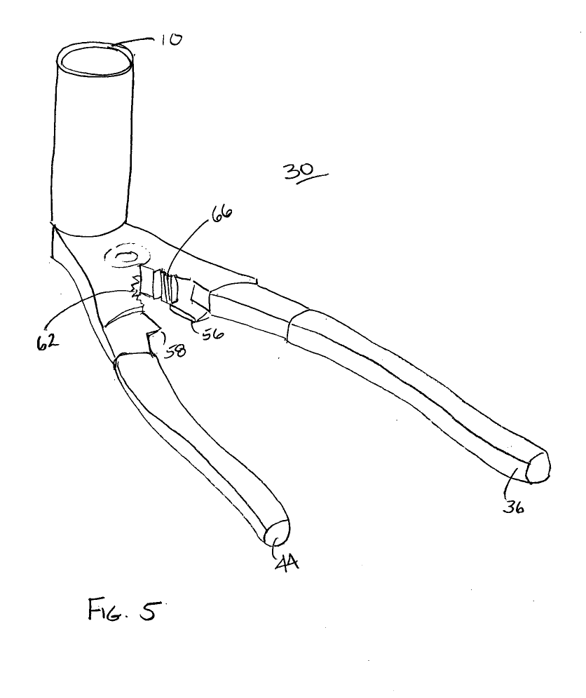

FIG. 4 is a perspective drawing of a tool 30 for flexible pipe used to clamp a ring 12 in accordance with one embodiment of the invention. The crimping blades 56, 58 are placed that as the user moves the handles 36, 44 together the clamp 12 will be crimped. The figure also shows the uncrimping parts 60, 62 of the tool. The uncrimping parts 60, 62 are placed along (same direction as the tool in FIG. 4) the crimped portion 20 (see FIG. 1) of the ring 12, holding the crimped portion firmly with the tool 30 the tool is rotated less than ninety degrees and the crimp opens. This allows the ring 12 to be repositioned or removed from the fitting. This allows the ring 12 to be reused. Presently most installers of sprinkling systems cut the ring 12 open and have to use a new ring 12. Not only is this more expensive, but it requires another tool and additional time.

FIG. 5 is a perspective view of a tool 30 for flexible pipe 10 preparing for flaring a flexible pipe 10 in accordance with one embodiment of the invention. Note that only a portion of the flexible pipe 10 is shown in the figure. The user is planning on attaching an end 16 of a fitting 14 (See FIG. 1) to the flexible pipe 10. Once the pipe 10 has been placed over protruding truncated half pipe working portions 42 & 50, the user closes handles 36 and 40 and the end of the pipe 10 is flared.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A tool for flexible plastic pipe comprising:
a first handle having a first end and a second end, the first end functioning as a hand grip and the second end having a first protruding truncated half pipe working portion;
a second handle having a first end and a second end, the first end functioning as a hand grip and the second end having a second protruding truncated half pipe working portion; and
a pivot member connecting the first handle and the second handle.

2. The tool of claim 1, wherein the first protruding truncated half pipe working portion and the second protruding truncated half pipe working portion are opposing.

3. The tool of claim 2, wherein the first protruding truncated half pipe working portion and the second protruding truncated half pipe working portion form an essentially closed pipe when the tool is in an open position.

4. The tool of claim 1, wherein the first handle has a female pivot opening between the first end and the second end.

5. The tool of claim 4, wherein the second handle has a female pivot opening between the first end and the second end.

6. The tool of claim 1, wherein the first protruding truncated half pipe working portion is spaced from the second protruding truncated half pipe working portion when the tool is in a closed position.

7. The tool of claim 1, further including a first crimping member on the first handle and a second crimping member on the second handle.

8. The tool of claim 7, wherein the first crimping member is between the first end of the first handle and a female pivot opening of the first handle.

9. A tool for flexible plastic pipe comprising:
a first handle having a first end and a second end, the first end functioning as a first part of a hand grip and the second end having a first protruding truncated half pipe working portion;
a second handle opposing the first handle having a first end and a second end, the first end functioning as a second part of a hand grip and the second end having a second protruding truncated half pipe working portion; and
an attachment member connecting the first handle to the second handle.

10. The tool of claim 9, further including a first crimping blade on the first handle and a second crimping blade on the second handle.

11. The tool of claim 10, wherein the attachment member is a pivot pin.

12. The tool of claim 11, wherein the second crimping blade is between the first end of the second handle and the pivot pin.

13. The tool of claim 9, wherein the first handle does not cross over the second handle.

14. A tool for flexible plastic pipe comprising:
a first handle having a first end and a second end, the first end functioning as a first part of a hand grip and a first crimping member formed in the first handle;
a second handle having a first end and a second end, the first end functioning as a second part of a hand grip and a second crimping member formed in the second handle; and
a pivot pin coupling the first handle to the second handle, wherein the first crimping member is between the first pivot pin and the hand grip.

15. The tool of claim 14, wherein the first handle includes a first protruding working portion.

16. The tool of claim 15, wherein the second handle includes a second protruding working portion.

17 The tool of claim 15, wherein the first protruding working portion is on the second end of the first handle.

18. The tool of claim 16, wherein the first protruding working portion and the second protruding portion are opposing.

19. The tool of claim 14, further including a first uncrimping part on the first handle and a second uncrimping part on the second handle.

20. The tool of claim 19, wherein the second uncrimping part is between the first end of the second handle and the pivot pin.
